(19) United States
(12) Patent Application Publication
(10) Pub. No.: US 2013/0100230 A1
(43) Pub. Date: Apr. 25, 2013

(54) SYSTEMS, METHODS, AND APPARATUS FOR METAL DETECTION, VIEWING, AND COMMUNICATIONS

(71) Applicant: REVOLUTIONARY CONCEPTS, INC., Matthews, NC (US)

(72) Inventor: Ronald Carter, Matthews, NC (US)

(73) Assignee: REVOLUTIONARY CONCEPTS, INC., Matthews, NC (US)

(21) Appl. No.: 13/716,071

(22) Filed: Dec. 14, 2012

Related U.S. Application Data
(63) Continuation of application No. 12/464,093, filed on May 11, 2009, now abandoned.
(60) Provisional application No. 61/052,240, filed on May 11, 2008.

(51) Int. Cl. H04N 7/18; H04N 7/14

(52) U.S. Cl. CPC H04N 7/18; H04N 7/14
USPC 348/14.01; 348/143

(57) ABSTRACT

A detection and viewing system includes a wireless device associated with a door and configured to communicate video data, the wireless device including a camera for providing the video data; a sensor for activating the camera, the sensor comprising a metal detector; a plurality of peripheral devices, each peripheral device associated with a respective user; and a computer configured for communication with the wireless device and configured for communication with each of the peripheral devices; wherein the computer executes software, in accordance with which, video data from the wireless device is received by the computer upon actuation of the sensor, and video data from the wireless device is accessible by each respective user using one of the peripheral devices.

### CROSS-REFERENCE TO RELATED APPLICATION

The present application is a U.S. continuation patent application of, and claims priority under 35 U.S.C. §120 to, U.S. nonprovisional patent application Ser. No. 12/464,093, filed May 11, 2009, which nonprovisional patent application published as U.S. patent application publication no. 2009/0278683, which patent application and any patent application publications thereof, including U.S. patent application publication no. 2009/0278683, are hereby incorporated herein by reference, and which '093 application is a U.S. nonprovisional patent application of, and claims priority under 35 U.S.C. §119(e) to, U.S. provisional patent application Ser. No. 61/052,240, filed May 11, 2008, which provisional patent application is incorporated by reference herein, and a copy of which is attached hereto as Appendix A, which is hereby incorporated herein by reference.

The present application also hereby incorporates herein by reference
(a) U.S. Pat. No. 7,193,644, issued Mar. 20, 2007, titled “Automated Audio Video Messaging And Answering System”;
(b) U.S. Patent Application Publication No. 2007/0188612, published Aug. 16, 2007, titled “Video System for Individually Selecting and Viewing Events at a Venue”;
(c) U.S. Patent Application Publication No. 2007/0103541, published May 10, 2007, titled “Two-Way Audio-Video Communication Method For Receiving Person At Entrance”.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to metal detection and viewing systems.

A need exists for improvement in metal detection and viewing systems. This, and other needs, are addressed by one or more aspects of the present invention.

### SUMMARY OF THE INVENTION

The present invention includes many aspects and features. Moreover, while many aspects and features relate to, and are described in, the context of metal detection and viewing, the present invention is not limited to use only in metal detection and viewing, as will become apparent from the following summaries and detailed descriptions of aspects, features, and one or more embodiments of the present invention.

Accordingly, one aspect of the present invention relates to a detection and viewing system, comprising a wireless device associated with a door and configured to communicate video data, the wireless device including a camera for providing the video data; a sensor for activating the camera, the sensor comprising a metal detector; a plurality of peripheral devices, each peripheral device associated with a respective user; and a computer configured for communication with the wireless device and configured for communication with each of the peripheral devices; wherein the computer executes software, in accordance with which, video data from the wireless device is received by the computer upon actuation of the sensor, and video data from the wireless device is accessible by each respective user using one of the peripheral devices.

In a feature of this aspect of the invention, the software maintains an association of each of the peripheral devices with a respective user.

In a feature of this aspect of the invention, the software provides a graphical user interface through which the video data from the wireless device is accessed by each respective user using one of the peripheral devices.

In a feature of this aspect of the invention, the metal detector is arranged at the door such that a person passing through the door passes through the metal detector.

In a feature of this aspect of the invention, the metal detector is configured to detect a firearm.

In a feature of this aspect of the invention, the system is utilized at a school.

In a feature of this aspect of the invention, the system is utilized at a college or university.

In a feature of this aspect of the invention, the system is utilized at a public facility.

In a feature of this aspect of the invention, the system further includes a microphone and a speaker located proximate the sensor, and a user may communicate remotely using a respective peripheral device with a person local to the sensor.

Another aspect of the present invention relates to a method for receiving a person at a door, comprising the steps of detecting, with a sensor located at a door, the possible presence of a firearm passing through the door; transmitting, to a computerized controller running a software application, video of the person at the door recorded using a camera located proximate the door; and providing, with the software application running at the computerized controller, a graphic user interface to a remote peripheral device by which a user of the remote peripheral device may view the video of the person at the door.

In a feature of this aspect of the invention, the method further includes the step of saving, in accordance with the software application running at the computerized controller, the video of the person at the door in a database in association with a timestamp.

In a feature of this aspect of the invention, the video is viewed using the remote peripheral device in real-time.

In a feature of this aspect of the invention, the video is streamed to the remote peripheral device.

In a feature of this aspect of the invention, the method further includes the step of transmitting, to the computerized controller running the software application, audio of the person at the door recorded using a microphone located proximate the door; wherein the graphic user interface provided to the remote peripheral device further enables a user of the remote peripheral device to hear the audio of the person at the door.

In a feature of this aspect of the invention, the method further includes the step of playing a recorded message to the person at the door upon the detection of the possible presence of a firearm at the door with the sensor.

In a feature of this aspect of the invention, the method further includes controlling, by a user with the remote peripheral device, the recorded message that is played through a graphical user interface.

In a feature of this aspect of the invention, the recorded message is selected by the user from a plurality of recorded messages.

In a feature of this aspect of the invention, the recorded message includes audio and video, and where a display is located proximate the door for displaying the video.

In a feature of this aspect of the invention, the method further includes the step of posting, by the user from the remote peripheral device, a video message for presentation to a person at the door.

In a feature of this aspect of the invention, said remote peripheral device comprises a cell phone.

In a feature of this aspect of the invention, said remote peripheral device comprises a video phone.

In a feature of this aspect of the invention, said remote peripheral device comprises a computer.

In a feature of this aspect of the invention, said remote peripheral device comprises a personal digital assistant.

In a feature of this aspect of the invention, the method further includes remotely actuating the camera located proximate the door using the remote peripheral device.

In a feature of this aspect of the invention, said step of remotely actuating the camera includes zooming an image of the person at the door.

In a feature of this aspect of the invention, said step of remotely actuating the camera includes remotely moving the camera to change the view of the camera.

Another aspect of the present invention relates to a method for two-way audio-video communications between a first person at a door and a remote person, comprising the steps of detecting, with a sensor located proximate a door, the possible presence of a firearm passing through the door; and providing real time audio-video communications between a person at the door and a remote person using a wireless handheld device by, transmitting, to the wireless handheld device of the remote person, video of the person at the door recorded using a camera located proximate the door, transmitting, to the wireless handheld device of the remote person, audio of the person at the door recorded using a microphone located proximate the door, and transmitting, to a speaker located proximate the door for playing to the person at the door, audio of the remote person recorded using the wireless handheld device.

In a feature of this aspect of the invention, said transmitting includes wireless communications between both the camera and microphone located proximate the door and a computerized controller running a software application including a graphic user interface by which the audio-video communications between the person at the door and the remote person are established.

In a feature of this aspect of the invention, the method further includes the step of playing a recorded message to the person at the door upon the detection of the possible presence of a firearm with the sensor.

In a feature of this aspect of the invention, the method further includes determining, by a user with a remote peripheral device, the recorded message that is played through a graphical user interface.

In a feature of this aspect of the invention, the recorded message is selected by the user from a plurality of recorded messages.

In a feature of this aspect of the invention, the recorded message includes audio and video.

In a feature of this aspect of the invention, the method further includes the step of posting, by the user from a remote peripheral device, a video message for presentation to the person at the door.

In a feature of this aspect of the invention, the method further includes the step of saving a recording of the two-way audio-communications in a database for later playback.

In a feature of this aspect of the invention, the method further includes transmitting, to a video display located proximate the door for presentation to the person at the door, video of the remote person recorded using the wireless handheld device.

In a feature of this aspect of the invention, said transmitting includes communications over the Internet.

In a feature of this aspect of the invention, said transmitting includes communications over a cellular network.

In a feature of this aspect of the invention, said transmitting includes communications over a satellite network.

In a feature of this aspect of the invention, the method further includes remotely actuating the camera located proximate the door using the wireless handheld device.

In a feature of this aspect of the invention, said step of remotely actuating the camera includes zooming an image of the person at the door.

In a feature of this aspect of the invention, said step of remotely actuating the camera includes remotely moving the camera to change the view of the camera.

In addition to the aforementioned aspects and features of the present invention, it should be noted that the present invention further encompasses the various possible combinations and subcombinations of such aspects and features.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1A is an illustration of a metal detection and viewing system in accordance with one or more preferred embodiments of the present invention.

FIGS. 1B-C are alternate views of an exemplary preferred implementation of a metal detection and viewing system.

FIG. 2 is a close-up illustration of a module for use in the metal detection and viewing system of FIG. 1A.

FIG. 3 is a logical diagram of elements of a preferred metal detection and viewing system.

FIG. 4 is a flowchart of an exemplary use scenario of a system after a subject goes through an entrance.

FIG. 5A illustrates a metal detection and viewing system which includes an electronic display.

FIG. 5B illustrates a module which includes an electronic display.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

### Metal Detection and Viewing System

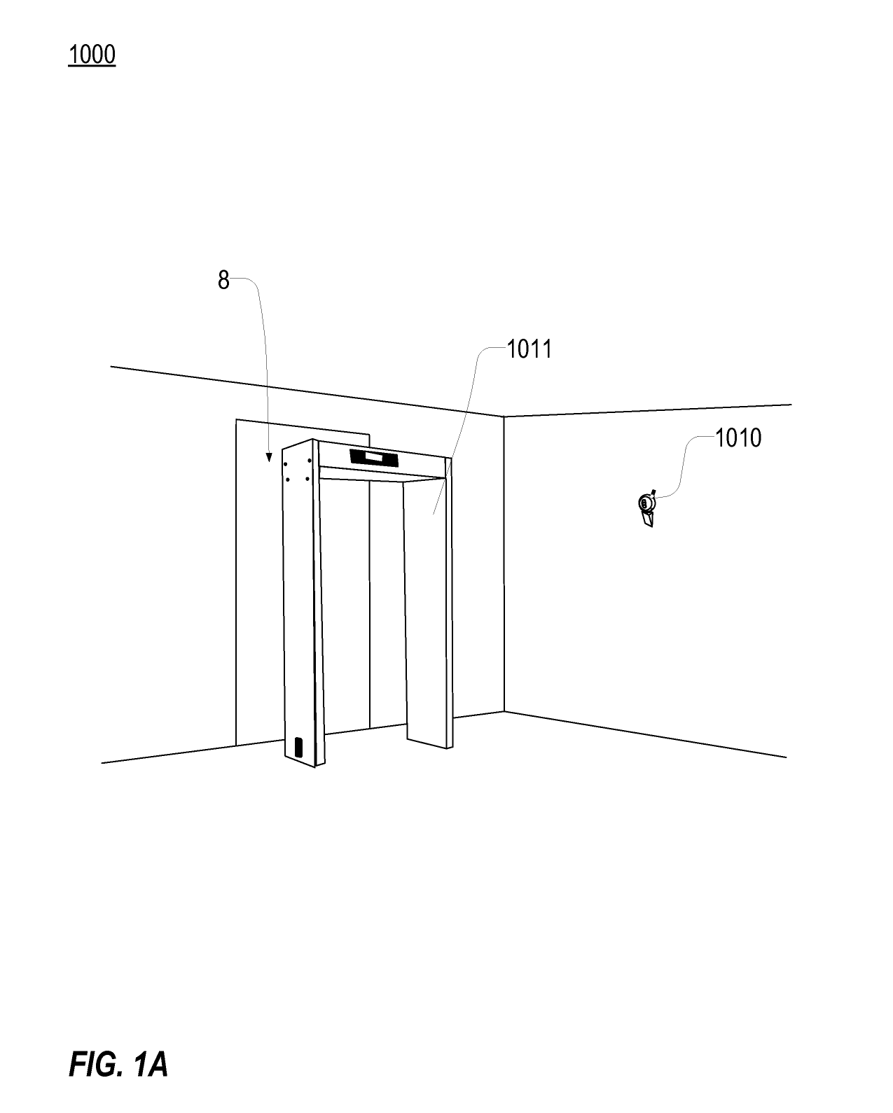

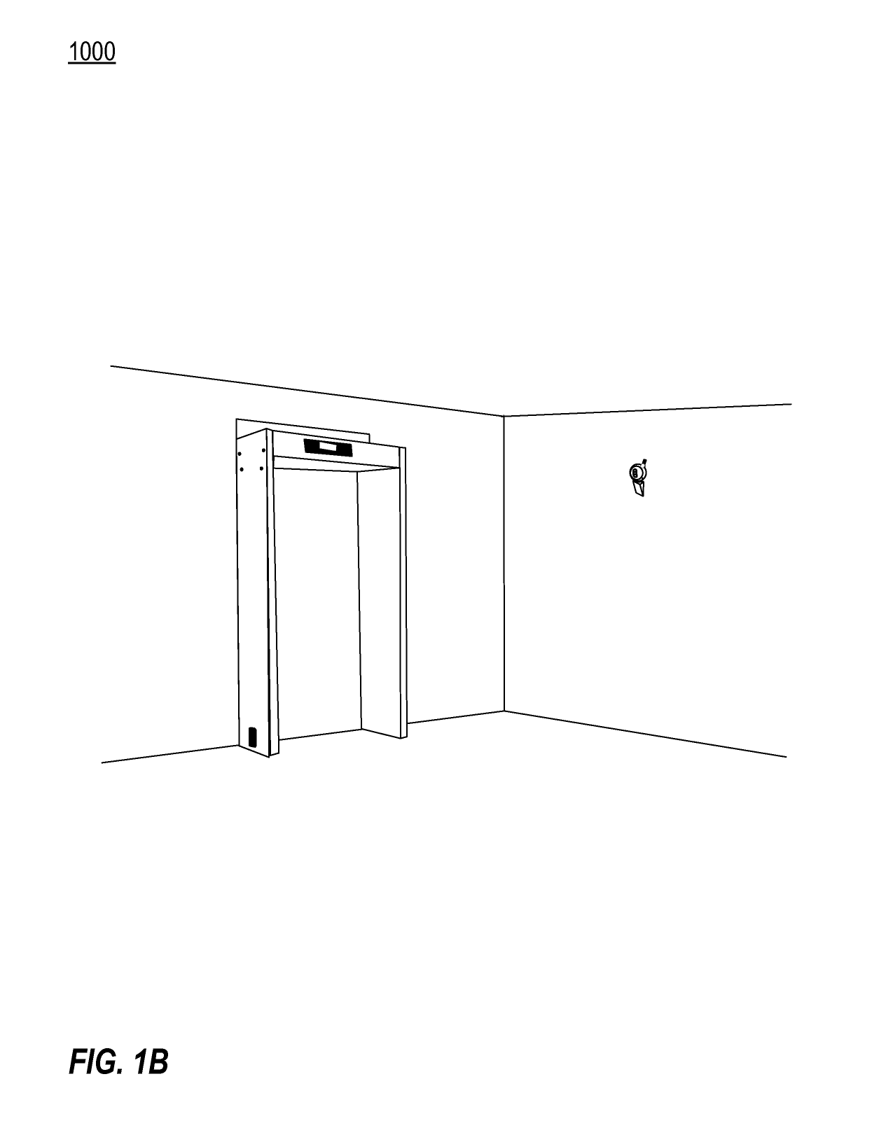

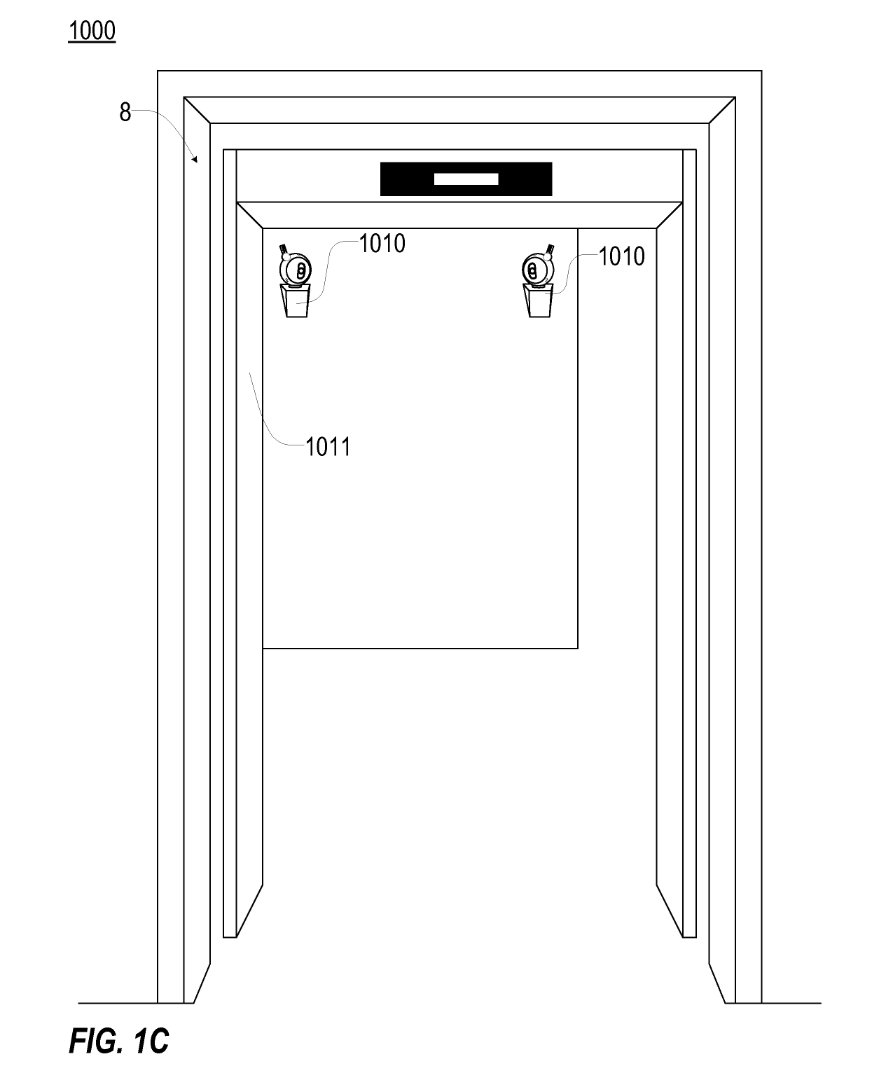

FIG. 1A illustrates a metal detection and viewing system 1000 in accordance with one or more preferred embodiments of the present invention. The system 1000 includes a metal detector 1011, one or more communications and surveillance modules 1010, and a camera 1022 disposed adjacent to an entrance 8. In one or more preferred embodiments, the metal detector 1011 is arranged such that a person passing through the entrance 8 must pass through the metal detector 1011, as illustrated in FIG. 1B.

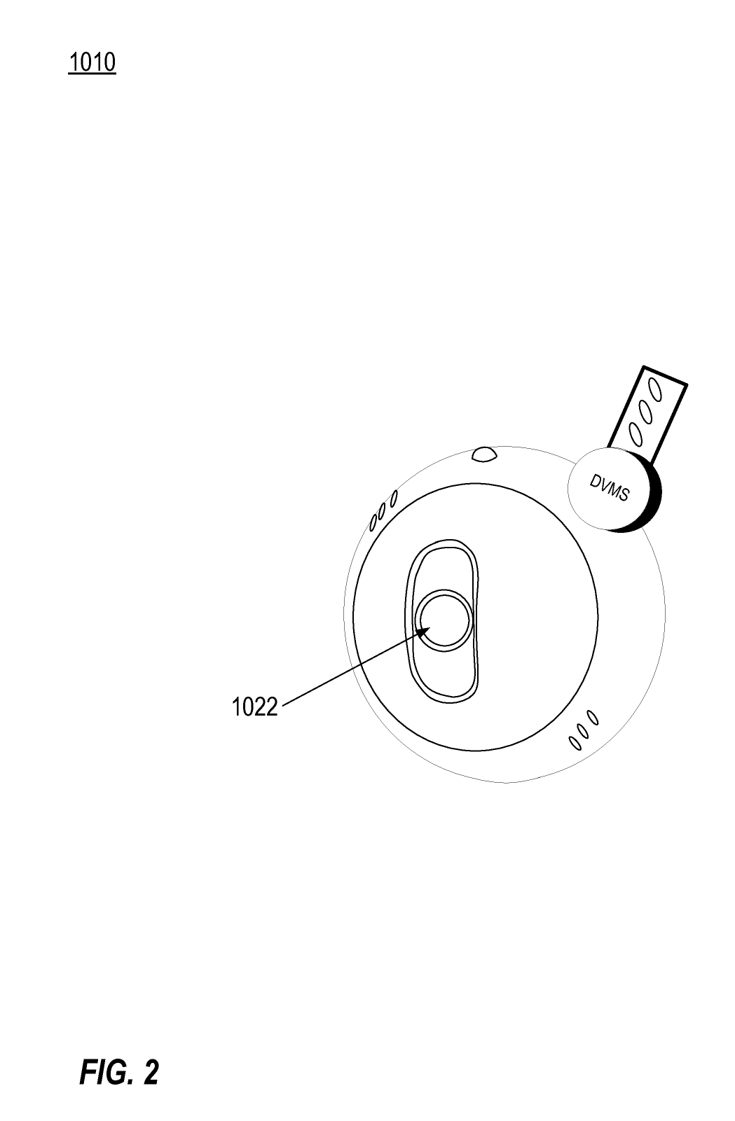

Further, in one or more preferred embodiments, the camera 1022 is a video camera, and is part of a module 1010, as illustrated in FIG. 2. In implementations utilizing multiple modules 1010, the modules 1010 are preferably placed in multiple locations in the positions that provide effective surveillance. An exemplary such implementation is illustrated collectively via FIGS. 1B and 1C, which are alternate views of the same preferred implementation.

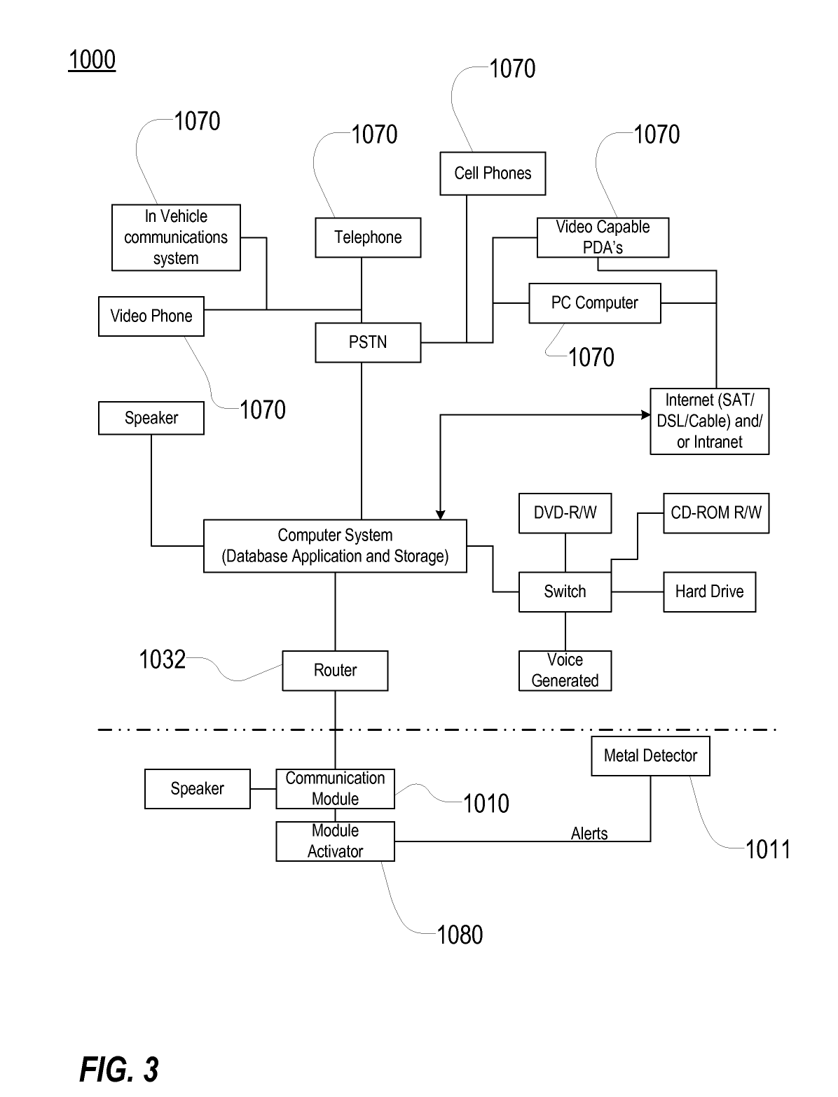

FIG. 3 is a logical diagram of elements of the system 1000. As illustrated in FIG. 2, the system 1000 includes a computer system 1012 which preferably includes some or all of the functionality of a computerized controller as disclosed in the incorporated references, such as U.S. Pat. No. 7,193,644 (for example, the computer system 1012 preferably has a battery backup, and a means for detecting a loss in electrical power).

The computer system 1012 is preferably in electronic communication with each module 1010, either via a router 1032 as illustrated, or directly. Such electronic communications can be either wired or wireless.

The system 1000 preferably further includes a module activator 1080. As its name implies, the module activator 1080 is configured to activate communications and surveillance modules 1010 of the system 1000.

As illustrated in FIG. 3, the module activator 1080 is in electronic communication with the metal detector 1011. Preferably, the system 1000 is configured such that when the metal detector 1011 detects abnormal amounts of metal, each module 1010 is activated via the module activator 1080.

The system preferably further includes a second sensor (the metal detector being the first), which in a preferred embodiment comprises a motion sensor. This second sensor is preferably a part of a module 1010, although it will be appreciated from the description herein that a second sensor of a module 1010 is preferably active independently of activation of that module 1010.

When the sensor detects the motion of a subject approaching the entrance 8, it zooms onto the subject, and the metal detector 1011 scans for abnormal amounts of metal. If abnormal amounts of metal are detected, the camera 1022 views the subject. In at least some embodiments, the camera 1022 is configured to zoom, tilt, and/or pan to the area of the subject. The camera 1022 is preferably configured to capture, transmit, and/or record images, stills, frames, or a video stream.

In a preferred embodiment, if abnormal amounts of metal are detected, the camera 1022 zooms, tilts, and/or pans to the area where the abnormal amounts have been detected.

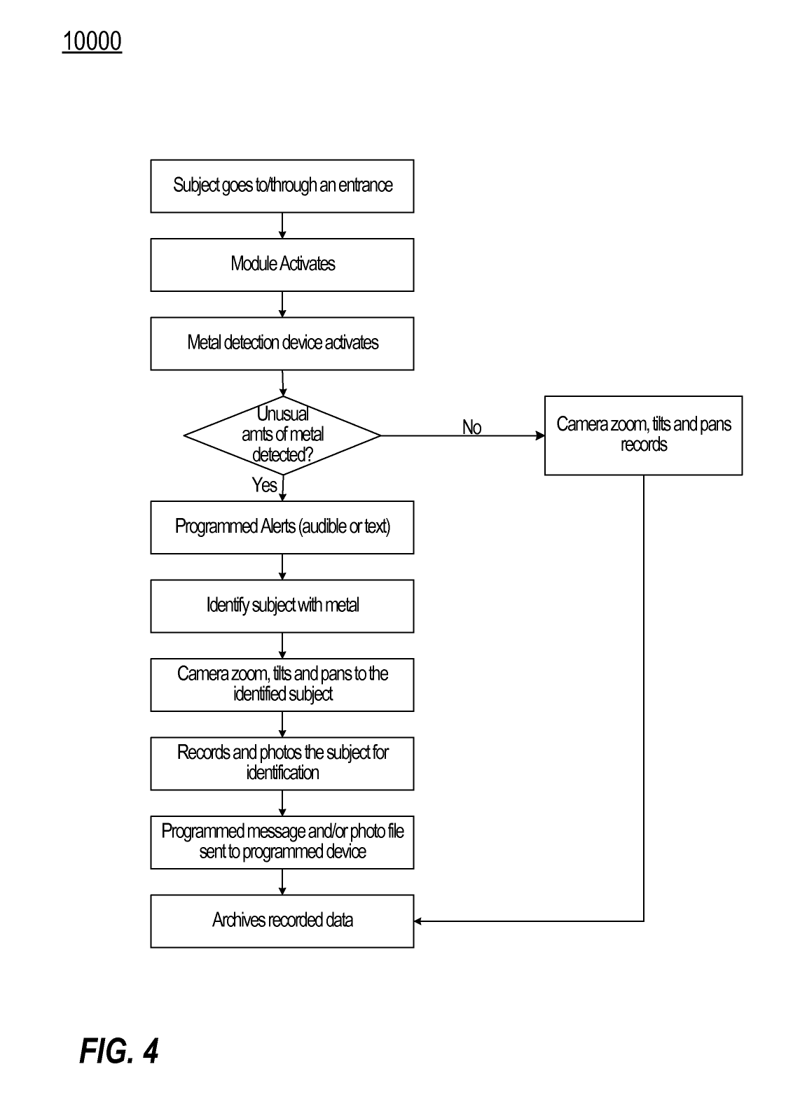

In at least some preferred embodiments, upon detection of abnormal amounts of metal, a programmed alert for further surveillance or search is also triggered. This may be classified as a security breach, and the recording may continue and allow for assessment as to whether it is necessary to dispatch additional assistance. Preferably, the computer system 1012 includes a DVMS database application that allows a user to define responses to prompts and events, such as, for example, detection of motion or metal. FIG. 4 illustrates an exemplary use scenario 10000 of a system 1000 after a subject goes through an entrance 8.

Video and images communicated from the camera of the module 1010, as well as other data, such as audio, communicated from the module 1010, is preferably stored on a storage device, such as a hard drive, of the computer system 1012. Preferably, upon activation of a module 1010, the camera of the module 1010 captures video and/or a still indicative of what caused its activation. In a preferred embodiment, a timestamp is captured as well, and saved at the computer system 1012 in association with captured video corresponding to that timestamp.

### Peripheral Devices

The system 1000 preferably further includes one or more peripheral devices 1070, each of which may either be a handheld device, such as a PDA, or a fixed device, such as a personal computer. Preferably, the system 1000 is designed to allow both direct communications, by peripheral devices, with the computer system 1012, and indirect communications, by peripheral devices 1070, through the Internet and the public switched telephone network (PSTN). FIG. 3 illustrates exemplary peripheral devices 1070 connected to the computer system 1012 via the PSTN or the Internet.

Peripheral devices 1070 configured for direct communications with the computer system 1012 are in direct contact via either a wireless radio frequency (RF) link, or a wired line. Peripheral devices 1070 in communication via an RF link communicate via short-range RF waves that have a direct view, and these peripheral devices 1070 are able to receive and convey messages to other similar peripheral devices 1070, as well as to the computerized controller 1012.

More remote peripheral devices 1070 generally are in communication via established institutional channels, such as the Internet, satellite systems, the PSTN, cell systems, cable systems, and, to a lesser extent, long wavelength systems. Such devices are selected from the group comprising cell phones, telephones, video-cell phones, computers, personal digital assistants, video-personal digital assistants, satellite telephones, transceivers, pagers, and other analog or digital communication devices.

Further, Wi-Fi connections may be utilized to connect a peripheral device 1070 of the system 1000 where necessary. A Wi-Fi connection may allow for the use of all peripheral devices 1070 which are compatible with the network.

The system 1000 preferably is configurable to accommodate an assortment of components. The components may include both hardware and software components. Software components of the system may be updated periodically with enhancements, and may even be reconfigured as necessary. The software is designed to communicate, locate, monitor, observe, and educate persons in contact with the system.

In a preferred embodiment, one or more components are software driven. A software driven module 1010 may be updated, modified, and customized for even more robust applications. Such a software driven module 1010 preferably includes a processor.

In one or more preferred embodiments, upon activation of a module 1010, two way communication is provided between the module 1010 and a peripheral device 1070. The two way communication preferably includes both audio and visual components utilizing the camera 1022, and a microphone and speakers of the module 1010, but in alternative embodiments may include only audio components or only visual components.

Additionally, video and/or images captured by the camera of the module 1010 are preferably viewable on a peripheral device 1070, for example as part of two way communications. Further, the camera of the module 1010 is preferably configured to allow a user of the peripheral device 1070 to tilt, pan, and zoom the camera 1022.

In a preferred embodiment, the system 1000 includes a plurality of peripheral modules 1070, each of which is associated with a respective user. Data indicative of these associations is maintained by the computer system 1012.

The system 1000 is preferably configured to provide a graphical user interface to peripheral devices 1070. A user of a peripheral device 1070 can utilize the graphical user interface to access video data of a module 1010. Preferably, the system 1000 is configured to allow video from a module 1010 to be streamed in real time to a peripheral device 1070.

### Video Communications

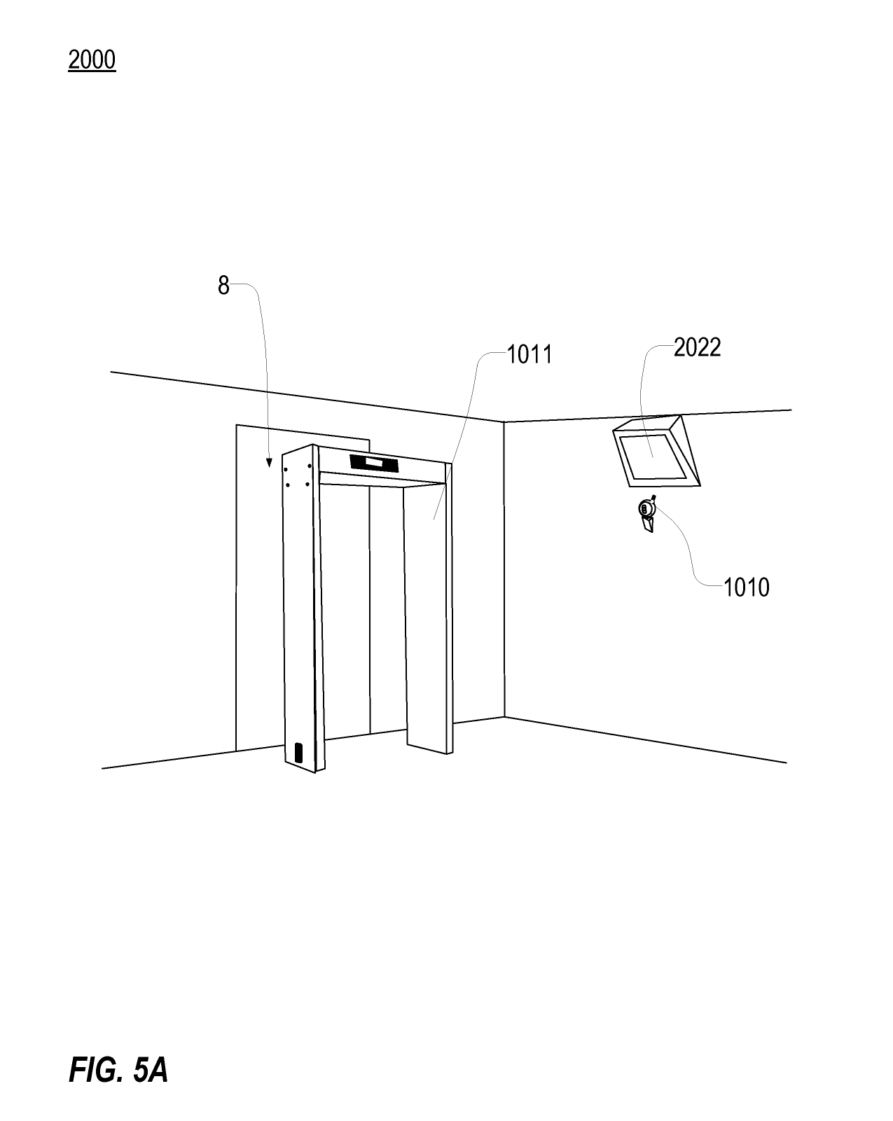

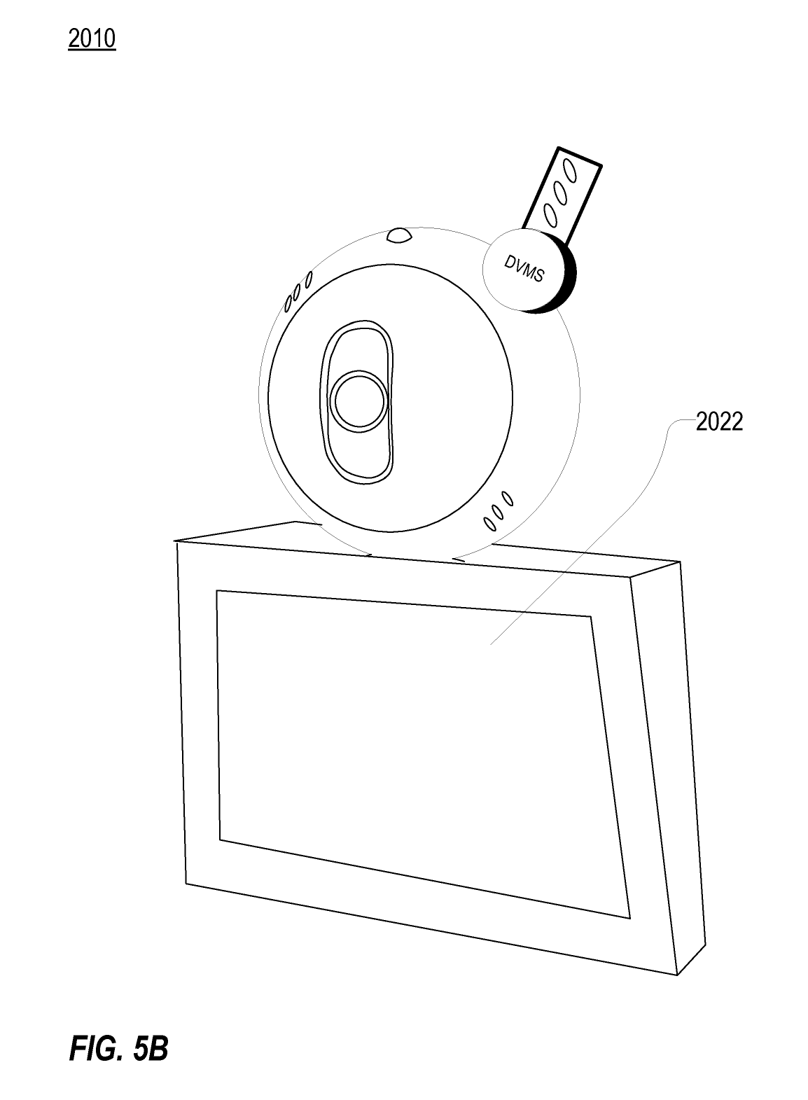

FIG. 5A illustrates a metal detection and viewing system 2000, which is similar to the system 1000, but further includes an electronic display 2027 for two way video communications between a module 1010 and a peripheral device 1070, which preferably includes a video camera. In preferred embodiments, the display 2027 is a part of a module 2010, as illustrated in FIG. 5B.

### Recorded Messages

In a preferred embodiment, a metal detection and viewing system 1000,2000 is configured to allow a user to play a recorded message via speakers of one or more communication modules 1010,2010, and, if a display 2027 is provided, via the display 2027 as well. Preferably, a user is allowed to select a recorded message to play from among a plurality of recorded messages via a graphical user interface on a peripheral device.

In a preferred embodiment, a system 1000,2000 further utilizes voice generation, e.g. a user can create voice-generated prompts for playing via a module 1010,2010.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A detection and viewing system, comprising:
(a) a wireless device associated with a door and configured to communicate video data, the wireless device including a camera for providing the video data;
(b) a sensor for activating the camera, the sensor comprising a metal detector;
(c) a plurality of peripheral devices, each peripheral device associated with a respective user; and
(d) a computer configured for communication with the wireless device and configured for communication with each of the peripheral devices;
(e) wherein the computer executes software, in accordance with which,
(i) video data from the wireless device is received by the computer upon actuation of the sensor, and
(ii) video data from the wireless device is accessible by each respective user using one of the peripheral devices.

2. The system of claim 1, wherein the software maintains an association of each of the peripheral devices with a respective user.

3. The system of claim 1, wherein the software provides a graphical user interface through which the video data from the wireless device is accessed by each respective user using one of the peripheral devices.

4. The system of claim 1, wherein the metal detector is arranged at the door such that a person passing through the door passes through the metal detector.

5. The system of claim 1, wherein the metal detector is configured to detect a firearm.

6. The system of claim 1, wherein the system is utilized at a school.

7. The system of claim 1, wherein the system is utilized at a college or university.

8. The system of claim 1, wherein the system is utilized at a public facility.

9. The system of claim 1, further comprising a microphone and a speaker located proximate the sensor, and wherein a user may communicate remotely using a respective peripheral device with a person local to the sensor.

10. A method for receiving a person at a door, comprising the steps of:
(a) detecting, with a sensor located at a door, the possible presence of a firearm passing through the door;
(b) transmitting, to a computerized controller running a software application, video of the person at the door recorded using a camera located proximate the door; and
(c) providing, with the software application running at the computerized controller, a graphic user interface to a remote peripheral device by which a user of the remote peripheral device may view the video of the person at the door.

11. The method of claim 10, further comprising the step of saving, in accordance with the software application running at the computerized controller, the video of the person at the door in a database in association with a timestamp.

12. The method of claim 10, wherein the video is viewed using the remote peripheral device in real-time.

13. The method of claim 10, wherein the video is streamed to the remote peripheral device.

14. The method of claim 10, further comprising the step of transmitting, to the computerized controller running the software application, audio of the person at the door recorded using a microphone located proximate the door; wherein the graphic user interface provided to the remote peripheral device further enables a user of the remote peripheral device to hear the audio of the person at the door.

15. The method of claim 10, further comprising the step of playing a recorded message to the person at the door upon the detection of the possible presence of a firearm at the door with the sensor.

16. The method of claim 15, further comprising controlling, by a user with the remote peripheral device, the recorded message that is played through a graphical user interface.

17. The method of claim 16, wherein the recorded message is selected by the user from a plurality of recorded messages.

18. The method of claim 16, wherein the recorded message includes audio and video, and where a display is located proximate the door for displaying the video.

19. The method of claim 10, further comprising the step of posting, by the user from the remote peripheral device, a video message for presentation to a person at the door.

20. The method of claim 10, wherein said remote peripheral device comprises a cell phone.

21. The method of claim 10, wherein said remote peripheral device comprises a video phone.

22. The method of claim 10, wherein said remote peripheral device comprises a computer.

23. The method of claim 10, wherein said remote peripheral device comprises a personal digital assistant.

24. The method of claim 10, further comprising remotely actuating the camera located proximate the door using the remote peripheral device.

25. The method of claim 24, wherein said step of remotely actuating the camera includes zooming an image of the person at the door.

26. The method of claim 24, wherein said step of remotely actuating the camera includes remotely moving the camera to change the view of the camera.

27. A method for two-way audio-video communications between a first person at a door and a remote person, comprising the steps of:
(a) detecting, with a sensor located proximate a door, the possible presence of a firearm passing through the door; and
(b) providing real time audio-video communications between a person at the door and a remote person using a wireless handheld device by,
(i) transmitting, to the wireless handheld device of the remote person, video of the person at the door recorded using a camera located proximate the door,
(ii) transmitting, to the wireless handheld device of the remote person, audio of the person at the door recorded using a microphone located proximate the door, and
(iii) transmitting, to a speaker located proximate the door for playing to the person at the door, audio of the remote person recorded using the wireless handheld device.

28. The method of claim 27, wherein said transmitting includes wireless communications between both the camera and microphone located proximate the door and a computerized controller running a software application including a graphic user interface by which the audio-video communications between the person at the door and the remote person are established.

29. The method of claim 27, further comprising the step of playing a recorded message to the person at the door upon the detection of the possible presence of a firearm with the sensor.

30. The method of claim 29, further comprising determining, by a user with a remote peripheral device, the recorded message that is played through a graphical user interface.

31. The method of claim 30, wherein the recorded message is selected by the user from a plurality of recorded messages.

32. The method of claim 30, wherein the recorded message includes audio and video.

33. The method of claim 27, further comprising the step of posting, by the user from a remote peripheral device, a video message for presentation to the person at the door.

34. The method of claim 27, wherein the wireless handheld device comprises a cell phone.

35. The method of claim 27, wherein the wireless handheld comprises a video phone.

36. The method of claim 27, wherein the wireless handheld comprises a personal digital assistant.

37. The method of claim 27, further comprising the step of saving a recording of the two-way audio-communications in a database for later playback.

38. The method of claim 27, further comprising transmitting, to a video display located proximate the door for presentation to the person at the door, video of the remote person recorded using the wireless handheld device.

39. The method of claim 27, wherein said transmitting includes communications over the Internet.

40. The method of claim 27, wherein said transmitting includes communications over a cellular network.

41. The method of claim 27, wherein said transmitting includes communications over a satellite network.

42. The method of claim 27, further comprising remotely actuating the camera located proximate the door using the wireless handheld device.

43. The method of claim 42, wherein said step of remotely actuating the camera includes zooming an image of the person at the door.

44. The method of claim 42, wherein said step of remotely actuating the camera includes remotely moving the camera to change the view of the camera.
